(19) United States
(12) Patent Application Publication
(10) Pub. No.: US 2010/0175984 A1
(43) Pub. Date: Jul. 15, 2010

(54) METHOD FOR MAKING NANOPARTICLES

(75) Inventors: Matthew David Butts, Rexford, NY (US); Qijia Fu, Shanghai (CN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/354,378

(22) Filed: Jan. 15, 2009

(51) Int. Cl. B01J 19/10; C01G 41/02

(52) U.S. Cl. 204/157.42; 423/606

(57) ABSTRACT

A method for making nanoparticles comprises: providing a water-in-oil microemulsion comprising water, sodium dioctyl sulfosuccinate and an oil phase; and adding a tungsten compound to the microemulsion. The molar ratio of water to sodium dioctyl sulfosuccinate is equal to or greater than 10.

### BACKGROUND

The invention generally pertains to a method for making nanoparticles.

Nanoparticles are the subject of intense scientific research because of their potential applications in optical and electronic materials as well as in biomedical research. Metal-based nanomaterials in particular have been studied extensively because of their wide applications in catalysis, electronics, magnetism and optics. Tungsten oxide is a material of great interest because of its unique electrochromic, catalytic and gas sensing properties. It has applications in solar energy devices, for instance. Nanostructured tungsten oxide leads to enhanced performance, for example, by providing greater surface area in sensing applications. Preparing nanostructured materials, however, presents challenges. Producing ordered arrays of tungsten oxide nanoparticles within certain size ranges is particularly challenging because of the lack of known methods for synthesizing tungsten oxide particles in the 10 to 100 nm size range with a narrow particle size distribution. Known spherical particle synthetic methods typically lack sufficient control over the relative rates of nucleation and growth to approach monodispersity. Scalability is also an issue with “wet chemistry” techniques for nanoparticle synthesis.

There have been many reports of the synthesis of nanoparticles in the literature, some of which address tungsten oxide. For example, techniques include the decomposition/oxidation of tungsten carbonyl and the hydrolysis of tungsten chloride. The disadvantages of these and other reported methods are that they provide particles that are too small for certain applications (e.g. less than 20 nm in diameter), have a broad particle size distribution (standard deviation >35%), result in agglomerated material, have shapes other than spherical, or have any combination of these disadvantages. The decomposition of tungstic acid in reverse microemulsions has been reported, however the resulting particles aggregate to larger structures due to destabilization of the microemulsion over the course of the experiment.

There is a need in the industry for methods for making regularly shaped, well dispersed, and size controlled nanoparticles.

### SUMMARY

In some aspects, embodiments disclosed herein provide a method for making nanoparticles comprising: (1) providing a water-in-oil microemulsion comprising sodium dioctyl sulfosuccinate (SDSS), an oil phase and water, and (2) adding a tungsten compound to the microemulsion to generate a reaction mixture. The molar ratio of water to sodium dioctyl sulfosuccinate is equal to or greater than 10.

The foregoing has outlined rather broadly the features of the present disclosure in order that the detailed description that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions which refer to the accompanying drawings:

FIG. 1 shows an SEM (scanning electron microscopy) image of obtained nanoparticles when [water]:[sodium dioctyl sulfosuccinate (SDSS)]=[water]:[W]=30 in a first experimental example; and

FIG. 2 illustrates an SEM image of obtained nanoparticles when [water]:[SDSS]=[water]:[W]=20 in a second experimental example.

### DETAILED DESCRIPTION OF THE INVENTION

In the following description, specific details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted in as much as such details are not necessary to obtain a complete understanding of the present invention and are within the skills of persons of ordinary skill in the relevant art.

Referring to the figures in general, it will be understood that the images and data are for the purpose of describing a particular embodiment of the invention and are not intended to limit the invention thereto.

In some embodiments, the present disclosure relates to a method for making nanoparticles, comprising the following steps: (1) providing a water-in-oil microemulsion comprising sodium dioctyl sulfosuccinate (SDSS), an oil phase and water; and (2) adding a tungsten compound to the microemulsion to generate a reaction mixture. The molar ratio of water to sodium dioctyl sulfosuccinate is equal to or greater than 10.

The oil phase may be a hydrocarbon or a mixture of hydrocarbons and in some specific embodiments, may be heptane, for instance. In some embodiments, the microemulsion is sonicated before the tungsten compound is added. In other embodiments, the microemulsion is thoroughly mixed by shaking or by vortex mixing without sonication. The tungsten compound may be a tungsten halide or a tungsten alkoxide. In some specific embodiments, the tungsten compound may be tungsten ethoxide. The tungsten hydrolysis reaction mixture may be stirred, sonicated, such as in a sonication bath, or both. The temperature of the tungsten compound hydrolysis reaction in the reaction mixture is typically in the range of about 15° C. to about 75° C.

In some embodiments, the molar ratio of water to sodium dioctyl sulfosuccinate is in a range from about 10 to about 30. In some embodiments, the molar ratio of water to tungsten in the reaction mixture is about the same as the molar ratio of water to the sodium dioctyl sulfosuccinate.

The method may comprise a step of separating the nanoparticles from the reaction mixture. For example, the nanoparticles may be washed with a solvent such as ethanol or acetone and isolated by centrifugation at or around room temperature followed by drying. Several washings may be carried out.

While most of the terms used herein will be recognizable to those of skill in the art, the following definitions are nevertheless put forth to aid in the understanding of the present disclosure. It should be understood, however, that when not explicitly defined, terms should be interpreted as adopting a meaning presently accepted by those of skill in the art.

“Microemulsion”, as defined herein, generally refers to optically clear, stable, isotropic liquid mixtures of an oil phase, water and surfactant, sometimes in combination with a cosurfactant or mixture of surfactants. The aqueous phase may contain salt(s) and/or other ingredients, and the “oil phase” may actually be a complex mixture of different hydrocarbons, olefins or other liquids that are immiscible with water.

“Nanoscale,” as defined herein, generally refers to dimensions below 1000 nm.

“Nanoparticles,” as defined herein, generally refer to particles that are nanoscale in at least one dimension. Nanoparticles disclosed herein may be useful in, among other applications, photonics and sensing.

The tungsten oxide nanoparticles made by the method of the present invention may be reduced to the pure metal by methods such as high temperature reduction under an atmosphere containing hydrogen, or by chemical reduction processes that apply reducing agents in solvent mixtures, for example. High temperature reduction may be carried out on the isolated, dry powder product at a temperature of at least 600° C. under a reducing atmosphere. Chemical reducing agents may be used to reduce the particles in solvent. Preferred reducing agents include lithium triethylborohydride, sodium tetraborohydride, lithium aluminum hydride and other agents known to those skilled in the art at a temperature ranging from about 10° C. to about 120° C.

### Experimental Examples

The following examples are provided to more fully illustrate some of the embodiments disclosed hereinabove. It should be appreciated by those of skill in the art that the techniques disclosed in the following examples represent techniques that constitute exemplary modes for practice of the present invention. However, those of skill in the art should, in light of the present disclosure, appreciate that many changes can be made in the specific embodiments that are disclosed and still obtain a like or similar result without departing from the spirit and scope of the invention.

In a first experimental example where [water]:[sodium dioctyl sulfosuccinate (SDSS)]=[water]:[W]=30, sodium dioctyl sulfosuccinate (SDSS, 600 mg) was weighed out into a 20 mL vial. Heptane (4.4 g) was then added, and the solution was mixed well. Deionized water (0.75 mL) was added by syringe. After shaking by hand for about 1 minute, the solution was optically clear. The microemulsion was sonicated for 20 minutes in a sonication bath. Tungsten ethoxide (0.39 mL, 1.38 mmol W) was added by syringe dropwise with stirring under air. Within 30 minutes a white solid had precipitated. The mixture was sonicated in a sonication bath for 1 hour (˜50° C.). The solid settled easily and the clear colorless solution on top was decanted and discarded. 15 mL of absolute ethanol were added, and the milky mixture was poured into a centrifuge tube. The mixture was diluted to 30 mL total with absolute ethanol and centrifuged (5259 g's, 20 minutes). The top layer was poured off. The whitish solid was washed an additional 3 times with absolute ethanol (each washing had a total volume of 25 mL) and was dried under vacuum. The isolated yield was about 275 mg.

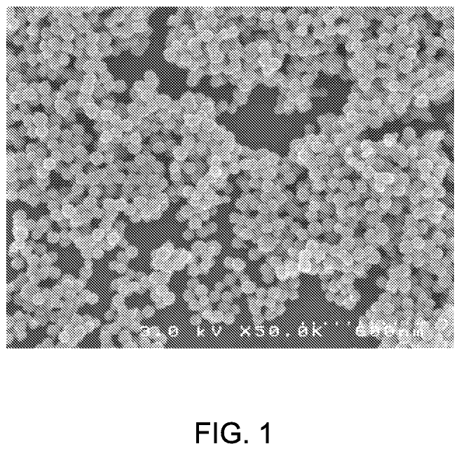

FIG. 1 shows an SEM image of obtained nanoparticles and Table 1 shows the size distribution statistics of the obtained particles. The mean size (diameter) of obtained nanoparticles was 55.4 nm with the minimum size being about 19 nm and the maximum size being about 102 nm as determined by image analysis. The particle size distribution of the nanoparticles was determined to be 55.4 nm±16.8% (± one standard deviation).

TABLE 1

| | Particle size (nm) | | | | | | | | | | | | | | | | |
|---|---|---|---|---|---|---|---|---|---|---|---|---|---|---|---|---|---|
| | 17.5 | 22.5 | 27.5 | 32.5 | 37.5 | 42.5 | 47.5 | 52.5 | 57.5 | 62.5 | 67.5 | 72.5 | 77.5 | 82.5 | 87.5 | 92.5 | 100 |
| Relative | 0 | 1 | 0 | 1 | 2 | 5 | 12 | 25 | 24 | 16 | 9 | 2 | 1 | 0 | 0 | 0 | 0 |
| number | | | | | | | | | | | | | | | | | |
| frequency | | | | | | | | | | | | | | | | | |
| (%) | | | | | | | | | | | | | | | | | |
| Cumulative | 0.23 | 1.60 | 1.83 | 2.97 | 4.58 | 9.61 | 21.9 | 46.6 | 70.9 | 87.4 | 96.8 | 98.8 | 99.5 | 99.7 | 99.7 | 99.7 | 100 |
| number | | | | | | | | | | | | | | | | | |
| (%) | | | | | | | | | | | | | | | | | |

Second and a third experiments have also been done under the reaction parameters described above except wherein the following molar ratios were established: [water]:[SDSS]=[water]:[W]=20 and 10, respectively.

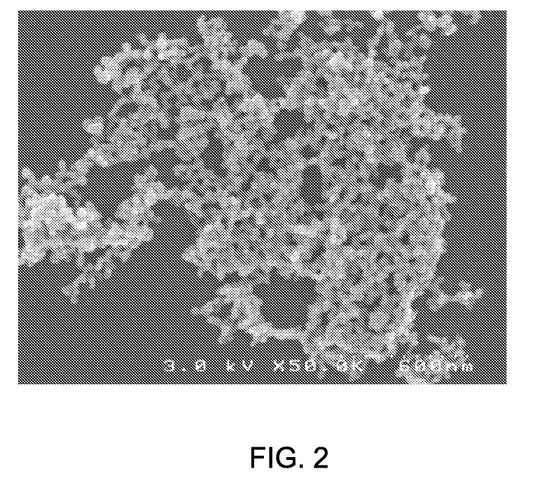

FIG. 2 shows an SEM image of the nanoparticle product of the second experiment when [water]:[SDSS]=[water]:[W]=20. Table 2 illustrates the size distribution statistics of the product.

TABLE 2

| | Particle size (nm) | | | | | | | | | | |
|---|---|---|---|---|---|---|---|---|---|---|---|
| | 2.5 | 7.5 | 12.5 | 17.5 | 22.5 | 27.5 | 32.5 | 37.5 | 42.5 | 47.5 | 52.5 |
| Relative | 0 | 0 | 0 | 3 | 20 | 39 | 25 | 8 | 2 | 1 | 0 |
| number | | | | | | | | | | | |
| frequency | | | | | | | | | | | |
| (%) | | | | | | | | | | | |
| Cumulative | 0.21 | 0.43 | 0.64 | 3.64 | 23.7 | 63.1 | 88.0 | 95.9 | 98.2 | 99.3 | 99.7 |
| number | | | | | | | | | | | |
| (%) | | | | | | | | | | | |

| | Particle size (nm) | | | | | | | | |
|---|---|---|---|---|---|---|---|---|---|
| | 57.5 | 62.5 | 67.5 | 72.5 | 77.5 | 82.5 | 87.5 | 92.5 | 97.5 |
| Relative | 0 | 0 | 0 | 0 | 0 | 0 | 0 | 0 | 0 |
| number | | | | | | | | | |
| frequency | | | | | | | | | |
| (%) | | | | | | | | | |
| Cumulative | 100 | 100 | 100 | 100 | 100 | 100 | 100 | 100 | 100 |
| number | | | | | | | | | |
| (%) | | | | | | | | | |

When the water-to-SDSS and water-to-W molar ratios were 20, the mean size (diameter) of obtained nanoparticles was 28.8 nm with the minimum size being about 3 nm and the maximum size being about 56 nm as determined by image analysis. The particle size distribution of the nanoparticles was determined to be 28.8 nm±20.8% (± one standard deviation).

Table 3 illustrates the size distribution statistics of the product of the third experiment when the water-to-SDSS and water-to-W molar ratios were 10. When the water-to-SDSS and water-to-W molar ratios were 10, the mean size (diameter) of obtained nanoparticles was 12.2 nm with the minimum size being about 3 nm and the maximum size being about 35 nm as determined by image analysis. The particle size distribution of the nanoparticles was determined to be 12.2 nm±33.6% (± one standard deviation).

TABLE 3

| | Particle size (nm) | | | | | | | | | | |
|---|---|---|---|---|---|---|---|---|---|---|---|
| | 2.5 | 7.5 | 12.5 | 17.5 | 22.5 | 27.5 | 32.5 | 37.5 | 42.5 | 47.5 | 52.5 |
| Relative | 1 | 28 | 52 | 14 | 3 | 0 | 1 | 0 | 0 | 0 | 0 |
| number | | | | | | | | | | | |
| frequency | | | | | | | | | | | |
| (%) | | | | | | | | | | | |
| Cumulative | 1.07 | 29.5 | 81.8 | 95.9 | 98.9 | 99.2 | 99.8 | 100 | 100 | 100 | 100 |
| number | | | | | | | | | | | |
| (%) | | | | | | | | | | | |

| | Particle size (nm) | | | | | | | | |
|---|---|---|---|---|---|---|---|---|---|
| | 57.5 | 62.5 | 67.5 | 72.5 | 77.5 | 82.5 | 87.5 | 92.5 | 97.5 |
| Relative | 0 | 0 | 0 | 0 | 0 | 0 | 0 | 0 | 0 |
| number | | | | | | | | | |
| frequency | | | | | | | | | |
| (%) | | | | | | | | | |
| Cumulative | 100 | 100 | 100 | 100 | 100 | 100 | 100 | 100 | 100 |
| number | | | | | | | | | |
| (%) | | | | | | | | | |

Advantageously, the method disclosed herein may be useful for providing regularly shaped, well dispersed and size controlled tungsten oxide nanoparticles with a narrow particle size distribution. The microemulsion reaction system of the present invention is surprisingly effective in providing for the synthesis and isolation of discrete, dispersible and spherical tungsten oxide particles in the 10-100 nm size range with a narrow size distribution. Discrete, spherical particles with a narrow size distribution that were not agglomerated or aggregated were not afforded in reactions based on the following water-in-oil microemulsion systems: water/heptane/1-hexanol/cetyltrimethylammonium bromide, water/heptane/1-pentanol/cetyltrimethylammonium bromide or water/heptane/Brij30.

It will be understood that certain of the above-described structures, functions, and operations of the above-described embodiments are not necessary to practice the present invention and are included in the description simply for completeness of an exemplary embodiment or set of embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A method for making nanoparticles, comprising:
providing a water-in-oil microemulsion comprising sodium dioctyl sulfosuccinate, water and an oil phase, and a molar ratio of water to sodium dioctyl sulfosuccinate being equal to or greater than 10; and
adding a tungsten compound to the microemulsion to generate a reaction mixture.

2. The method of claim 1, wherein a molar ratio of water to tungsten is the same as the molar ratio of water to sodium dioctyl sulfosuccinate.

3. The method of claim 1, wherein the molar ratio of water to sodium dioctyl sulfosuccinate is in a range of about 10 to about 30.

4. The method of claim 1, wherein the microemulsion is sonicated before the tungsten compound is added.

5. The method of claim 1, wherein the tungsten compound is a tungsten halide.

6. The method of claim 1, wherein the tungsten compound is a tungsten alkoxide.

7. The method of claim 1, wherein the tungsten compound is tungsten ethoxide.

8. The method of claim 1, wherein the oil phase is a hydrocarbon or mixture of hydrocarbons.

9. The method of claim 1, wherein the oil phase is heptane.

10. The method of claim 1, further comprising: separating nanoparticles from the reaction mixture.

11. The method of claim 10, wherein separating the nanoparticles from the reaction mixture comprises washing the nanoparticles and isolating by centrifugation.

12. The method of claim 1, wherein nanoparticles formed in the reaction mixture comprises tungsten oxide.

13. The method of claim 12, further comprising exposing the tungsten oxide nanoparticles to an atmosphere containing hydrogen at a temperature of at least 600° C.

14. The method of claim 12, further comprising reducing the tungsten oxide nanoparticles with one or more chemical reducing agents in solution.
